(19) United States
(12) Patent Application Publication
(10) Pub. No.: US 2014/0191143 A1
(43) Pub. Date: Jul. 10, 2014

(54) Optocoupler

(71) Applicant: CAPELLA MICROSYSTEMS (TAIWAN), INC., New Taipei City (TW)

(72) Inventors: CHENG-CHUNG SHIH, Fremont, CA (US); YUNG-CHUAN CHUANG, Taipei City (TW); CHIH-CHENG CHIEN, Taipei City (TW)

(73) Assignee: CAPELLA MICROSYSTEMS (TAIWAN), INC., New Taipei City (TW)

(21) Appl. No.: 13/842,957

(22) Filed: Mar. 15, 2013

(30) Foreign Application Priority Data
Jan. 4, 2013 (TW) 102100209

(51) Int. Cl. H04B 10/80

(52) U.S. Cl. CPC H04B 10/802
USPC 250/551

(57) ABSTRACT

An optocoupler is disclosed including a receiving unit, a metal bump, a substrate, a transparent light guiding block, a light emitting unit, and a transmitting unit. The metal bump is formed on the receiving unit and connects to the substrate. The transmitting unit is electrically connected to the light emitting unit, so as to selectively control whether the light emitting unit to emit the light or not. The metal bump is utilized to connect the substrate with the receiving unit, and then the transparent light guiding block is utilized to cover the light emitting unit, so as to simplify the structure of the optocoupler.

### CROSS-REFERENCE TO RELATED APPLICATION

This application claims the benefit of Taiwan Patent Application No. 102100209, filed on Jan. 4, 2013, in the Taiwan Intellectual Property Office, the disclosure of which is incorporated herein in its entirety by reference.

### BACKGROUND OF THE INVENTION

1. Field of the Invention

The present invention generally relates to an optocoupler, in particular to an optocoupler utilizing metal bumps to form a receiving unit on a substrate.

2. Description of the Related Art

The optocoupler is a safety circuit element, which transforms electrical signals to light signals and then back to electrical signals, thereby achieving well isolation between the input and output electrical signals. So far, the common optocoupler illustrated as FIG. 1 has a luminous chip 1, a photosense chip 3, a first light transmitting package adhesive 5, a second light transmitting package adhesive 6 and a third light isolating package adhesive 7. Wherein, the luminous chip 1 is disposed on a first support 2, so as to emit the light. The luminous chip 3 is disposed on the second support 4 faced to the first support 2, so as to make the photosense chip 3 face to the luminous chip 1 and receive the light emitted from the luminous chip 1. The first light transmitting package adhesive 5 covers the luminous chip 1. The second light transmitting package adhesive 6 covers the photosense chip 3. The third light transmitting package adhesive 7 covers the first light transmitting package adhesive 5 and the second light transmitting package adhesive 6.

As a result, the luminous chip I can be driven by the electrical signals to emit the light, and after the light pass through the first and second light transmitting package adhesive 5 and 6, the photosense chip 3 receives the light and generates the output electrical signals. The optocoupler utilizes the arrangement between the luminous chip 1 and the photosense chip 3 to perform the conversion of electrical to optical or optical to electrical. Accordingly, the optocoupler can avoid the damage at output terminal, such as burn down or malfunction, from situation of unstable electrical signals at input terminal such as impulse. However, the optocoupler needs multiple adhesive layers, which causes great complexity of structure.

### SUMMARY OF THE INVENTION

In light of the issues raised in prior art above, the primary objective of the present invention is to provide an optocoupler using metal bumps to connect the receiving unit and the substrate, so as to simplify the structure of the optocoupler.

To achieve the foregoing objective, the present invention provides an optocoupler comprising a receiving unit, a metal bump, a substrate, a transparent light guiding block, a light-emitting unit and the transmitting unit. The receiving unit includes photosensor disposed on a first surface of the receiving unit. The metal bump is formed on the first surface of the receiving unit. The substrate has a second surface faced to the first surface and the metal bump is connected to the substrate. The transparent light guiding block is connected to the photosensor and is arranged to guide the light to the photosensor. The light-emitting unit is covered by the transparent light guiding block. The transmitting unit is connected to the light-emitting unit and is arranged to selectively control the light-emitting unit to it the light or not.

Preferably, the metal bump may have a predetermined thickness, the transparent light guiding block is connected to both the photosensor and the second surface, and the light-emitting unit is faced to the photosensor.

Preferably, the transmitting unit may be placed on a side of the receiving unit and disposed on the second surface of the substrate.

Preferably, the substrate further may include a recess disposed on the second surface and faced to the photosensor, and the light-emitting unit is placed inside the recess.

Preferably, the substrate may have a metal connecting line electrically connected to the transmitting unit and the light-emitting unit, and the light-emitting unit is disposed opposite to the photosensor.

Preferably, the optocoupler further may include an opaque layer covering the receiving unit, the metal bump, the transparent light guiding block, the light-emitting unit and the transmitting unit.

Preferably, the receiving unit may be connected to the second surface of the substrate through the metal bump with the flip chip technology.

Preferably, the substrate may be a printed circuit board.

Preferably, the transparent light guiding block may be a transparent silicon material.

In summary, by forming the metal bump on the receiving unit and using the flip chip technology to connect the receiving unit with the substrate, the optocoupler of the present invention only needs to utilize the transparent light guide block seal the light-emitting unit and then cover the elements on the substrate by the opaque layer, and thus the optocoupler of the present invention will have more simpler structure compared to the conventional optocoupler which requires multiple package adhesives formed in the optocoupler. Besides, the optocoupler of the present invention forms a recess on the substrate and disposes the light-emitting unit in the recess, thereby reducing the thickness of the optocoupler of the present invention.

### BRIEF DESCRIPTION OF THE DRAWINGS

FIG. 1 is an optocoupler of prior art.

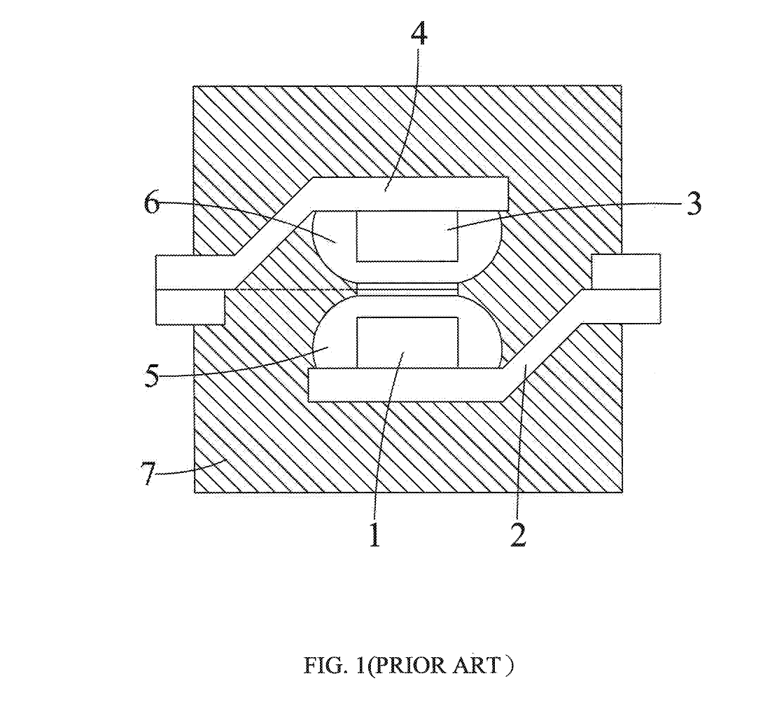

FIG. 2 is a schematic view of an optocoupler according to the first embodiment of the present invention.

FIG. 3 is a first schematic view of the optocoupler according to the second embodiment of the present invention.

FIG. 4 is the second optocoupler according to the second embodiment of the present invention.

FIG. 5 is a first schematic view of an optocoupler according to the third embodiment of the present invention.

FIG. 6 is the second optocoupler according to the third embodiment of the present invention.

FIG. 7 is a schematic view of an optocoupler according to the forth embodiment of the present invention.

### DETAILED DESCRIPTION OF THE PREFERRED EMBODIMENTS

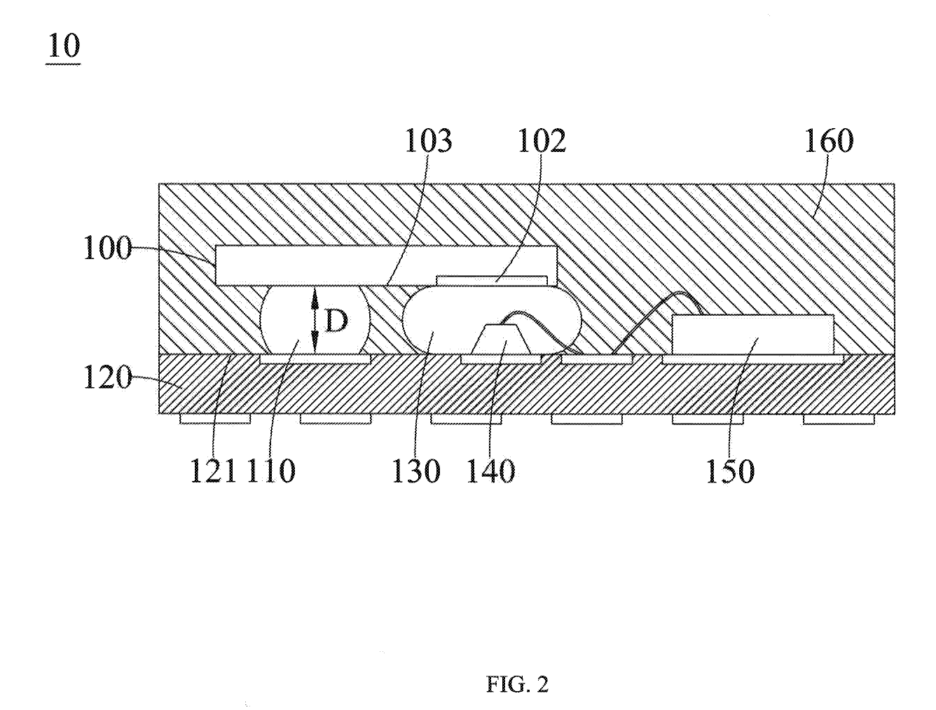

With reference to FIG. 2 for a schematic view of an optocoupler according to a first embodiment of the present invention. As illustrated, the optocoupler 10 comprises a receiving unit 100, a metal bump 110, a substrate 120, a transparent light guiding block 130, a light-emitting unit 140, a transmitting unit 150 and an opaque layer 160. Wherein, the receiving unit 100 comprises a photosensor 102 disposed on the first surface 103 of the receiving unit 100. The transparent light guiding block 130 is connected to the photosensor 102, so as to guide the light emitted from the light-emitting unit 140 to the photosensor 102. The transparent light guiding block 130 of the present embodiment is made of transparent silicon material, but is not limited thereto.

The metal bumps 110 are formed on the first surface 103 of the receiving unit 100 and is connected to the substrate 120. In more detail, the receiving unit 100 of the present invention utilizes the flip chip technology to form multiple metal bumps 110 on the first surface 103, and then connects the metal bumps 110 to the second surface 121 of the substrate 120. Wherein, the metal bumps 110 of the present invention can be a solder bump, but is not limited thereto. The substrate 120 can be a printed circuit board, but is not limited thereto.

The metal bumps 110 of the present embodiment have a predetermined thickness D which approximately equal to the distance between the first surface 103 of the receiving unit 100 and the second surface 121 of the substrate 120. The light-emitting unit 140 is disposed on the substrate 120 and is disposed opposite to the photosensor 102. That is, the light-emitting unit 140 is disposed between the substrate 120 and the photosensor 102, and the transparent light guiding block 103 covers the light-emitting unit 140 and is connected to the photosensor 102 and the second surface 121 of the substrate 120.

The light-emitting unit 140 is surrounded by the transparent light guiding block 130, so as to guide the light emitted by the light-emitting unit 140 to the photosensor 102. Wherein, the light-emitting unit 140 can be a light-emitting diode, but is not limited thereto.

The transmitting unit 150 is electrical connected to the light-emitting unit 140, so as to selectively control the light-emitting unit 140 to emit the light or not for transmitting the electrical signal. For example, when the light-emitting unit 140 emits the light, it can represent signal 1, and when the light-emitting unit 140 does not emit the light, it can represent signal 0.

The transmitting unit 150 may be placed at a side of the receiving unit 100, and disposed on the second surface 121 of the substrate. Wherein, the transmitting unit 150 of the present embodiment can be directly connected to the light-emitting unit 140 by the way of wire routing, but is not limited thereto. In another embodiment of the present invention, the transmitting unit 150 can be electrically connected to the light-emitting unit 140 by the way of wire bonding.

The opaque layer 160 covers the receiving unit 100, the metal bumps 110, the transparent light guiding block 130 and the transmitting unit 150. The opaque layer 160 of the present embodiment is made of black resin for absorbing the light, but is not limited thereto. In another embodiment of the present invention, the opaque layer 160 may be made of white resin for reflecting the light. As a result, the opaque layer 160 can be utilized to avoid the photosensor 102 receiving the light not emitted from the light-emitting unit 140, such as reflection light or surrounding light.

To be explained herein, there is preferably a distance between the light-emitting unit 140 and the receiving unit 100 for preventing the electrical signal from conduction between the light-emitting unit 140 and the receiving unit 100 through the transparent light guiding block 130. More specifically, there is generally extremely great voltage difference between the light-emitting unit 140 and the receiving unit 100 of the optocoupler 10. Even though the transparent light guiding block 130 is made of insulation material, due to the overly short distance between the light-emitting unit 140 and the receiving unit 100, the electrical arcs or surges may occur thereretween. Therefore, there is preferably a predetermined distance between the light-emitting unit 140 and the receiving unit 100, and the length of the predetermined distance is decided by the voltage tolerance of the material of the transparent light guiding block 130.

For example, the predetermined thickness of the metal bumps 110 of the present embodiment may be approximately 0.4 mm, and because the receiving unit 100 is connected to the substrate 120 through the metal bumps, the distance between the substrate 120 and the receiving unit 100 would also be approximately 0.4 mm. As a result, the light-emitting unit 140 can be disposed between the receiving unit 100 and the substrate 120. The distance is approximately 0.2 mm between the light-emitting unit 140 and the photosensor 102, so as to avoid accidental electrical conduction of electron between the photosensor 102 and the light-emitting unit 140 to interrupt the transmission of the light signal. Wherein the distance between the light-emitting unit 140 and the photosensor 102 can be decided by the voltage tolerance of the transparent light guiding block 130. Take the present embodiment for the example, the voltage is about 50 V between the light-emitting unit 140 and the photosensor 102, and the voltage tolerance of the transparent light guiding block is about 250 V/mm, so there should be at least 0.2 mm between the light-emitting unit 140 and the photosensor 102.

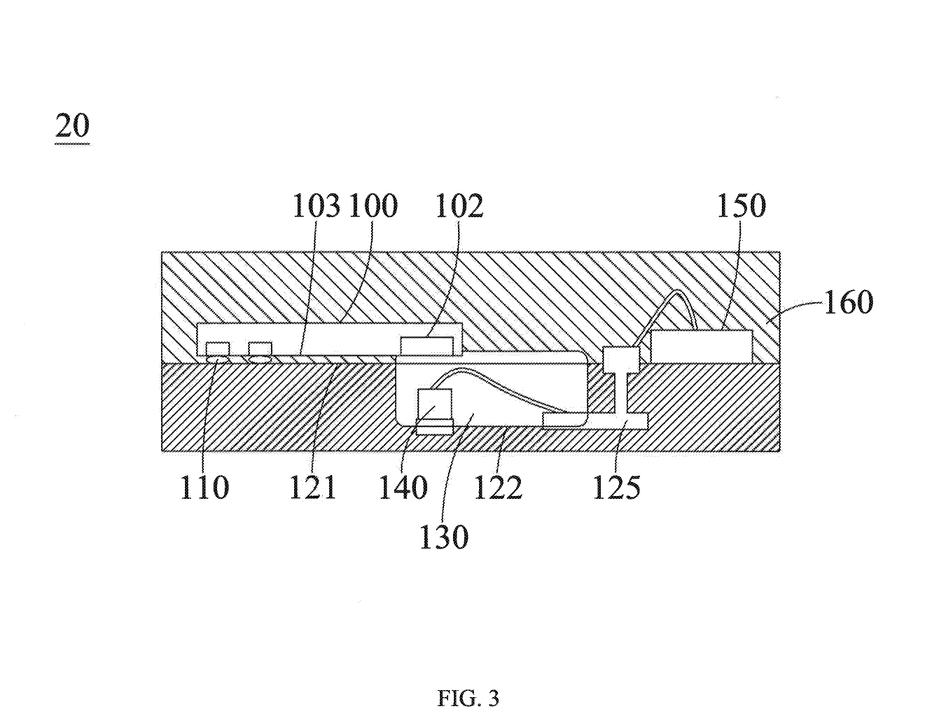

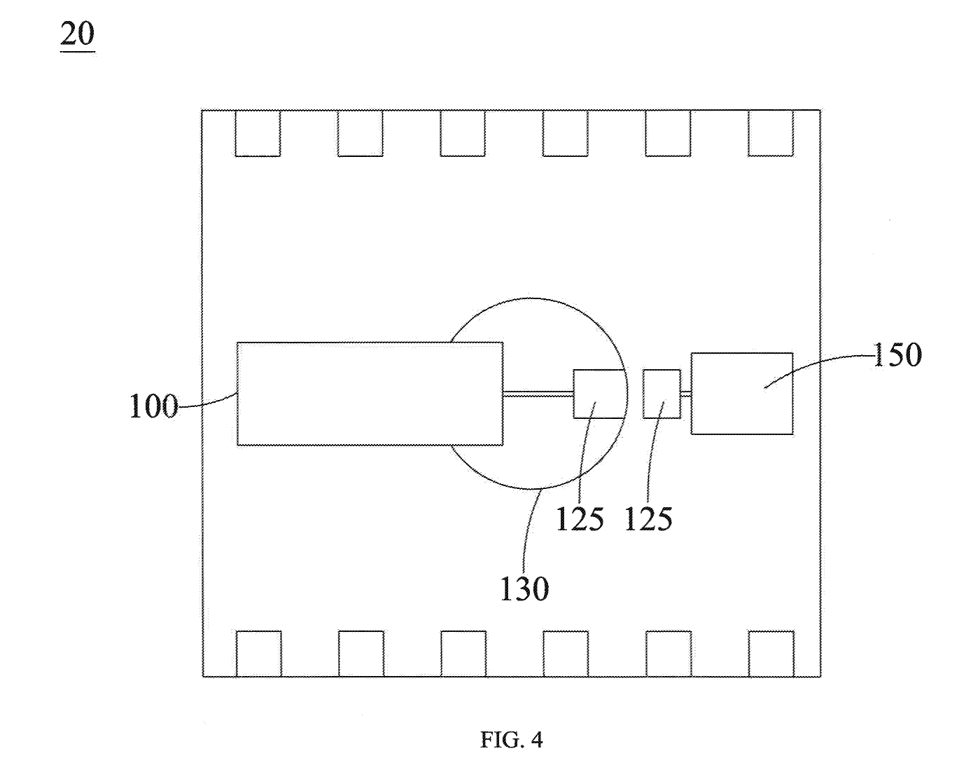

With reference to FIG. 3 and FIG. 4, FIG. 3 is a first schematic view of the optocoupler according to the second embodiment of the present invention, and FIG. 4 is the second optocoupler according to the second embodiment of the present invention. Wherein, the similar numerals between the present embodiment and the first embodiment denote the similar or the same element, which will be omitted herein. As illustrated, the optocoupler 20 of the present embodiment comprises a receiving unit 100, metal bumps 110, a substrate 120, a transparent light guiding block 130, a light-emitting unit 140, a transmitting unit 150 and an opaque layer 160.

Wherein, the difference between the present embodiment and the first embodiment is that the substrate 120 of the present embodiment further comprises a recess 122. The recess 122 is disposed on the second surface 121 of the substrate 120 and is faced to the photosensor 102. The light-emitting unit 140 is disposed on the bottom of the recess 122. As a result, the thickness of the metal bumps 110 of the present embodiment is smaller than that of the metal bumps 110 of the first embodiment. Accordingly, when the metal bumps 110 are formed on the first surface 103 of the receiving unit 130, smaller metal bumps 110 can be formed. That is, the present embodiment can use the ordinary flip chip technology applied in the industry to connect the receiving unit 100 to the substrate 120, and there is no need to customize the metal bumps having the predetermined thickness as the first embodiment.

By the configuration of the recess 122 of the present embodiment, the distance between the light-emitting unit 140 and the receiving unit 100 is long enough to prevent the accidental conduction of the electrical signals through the transparent light guiding block 130. It is worthy to mention that the light-emitting unit 140 of the present embodiment can be electrically connected to the transmitting unit 150 by using metal connecting lines 125 of the substrate 120, and thus the light-emitting unit 140 of the present embodiment can be disposed opposite to the photosensor 102, thereby increasing the sensibility of the transmission of the light signals.

Wherein, after the transparent light guiding block 130 covers the light-emitting unit 140 and the recess 122, and attaches to the photosensor 102, the black opaque layer 160 may cover the receiving unit 100, the metal bumps 110, the transparent light guiding block 130 and the transmitting unit 150. As a result, the light emitted by the light-emitting unit 140 can guide to the photosensor 102, and will not be affected by the surrounding light or reflection light.

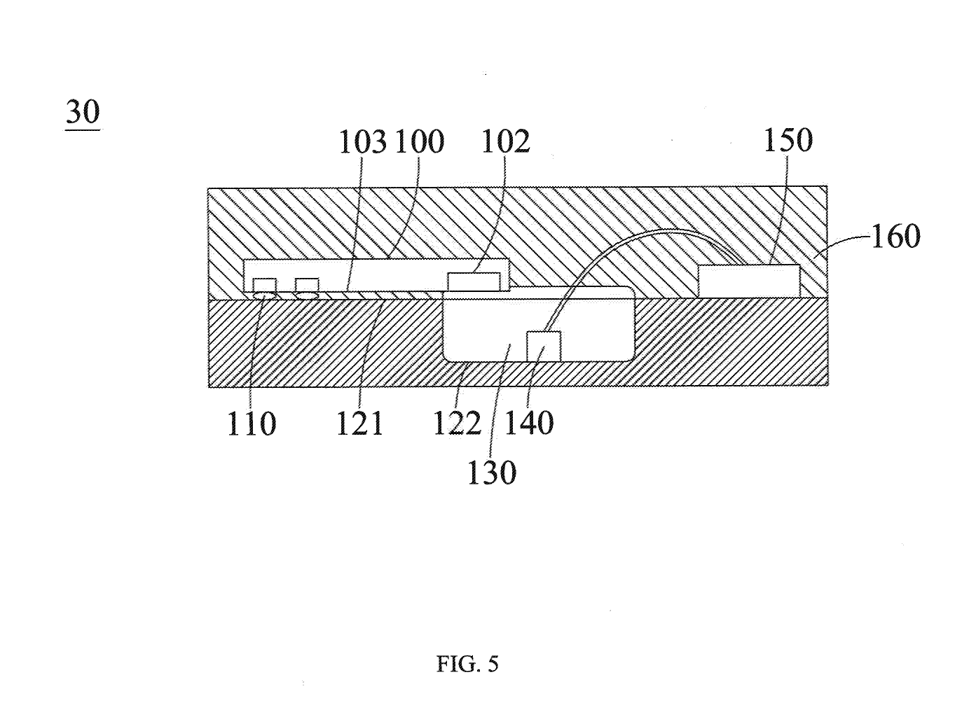

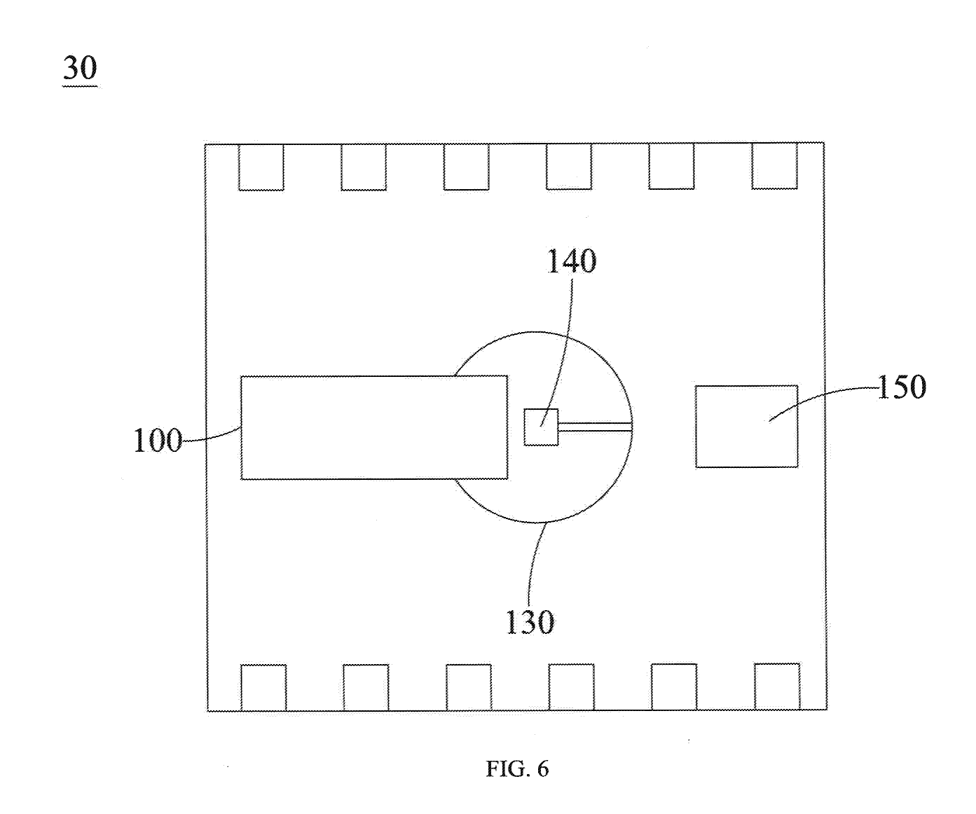

With reference to FIG. 5 and FIG. 6, FIG. 5 is a first schematic view of an optocoupler according to the third embodiment of the present invention, and FIG. 6 is the second optocoupler according to the third embodiment of the present invention. As illustrate, the similar numerals between the present embodiment and the above embodiments denote the similar or the same element, which will be omitted herein. The optocoupler 30 of the present embodiment comprises a receiving unit 100, a metal bumps 110, a substrate 120, a transparent light guiding block 130, a light-emitting unit 140, a transmitting unit 150 and an opaque layer 160. The substrate 120 comprises a recess 122 disposed on the second surface 121 of the substrate 120, and the light-emitting 140 is disposed on the bottom of the recess 122.

It is worthy of note that the difference between the present embodiment and the second embodiment is that the light-emitting unit 140 of the present embodiment is connected to the transmitting unit 150 through the way of wire routing. As a result, the manufacturing process of the present embodiment can omit the wire bonding step on the substrate 120.

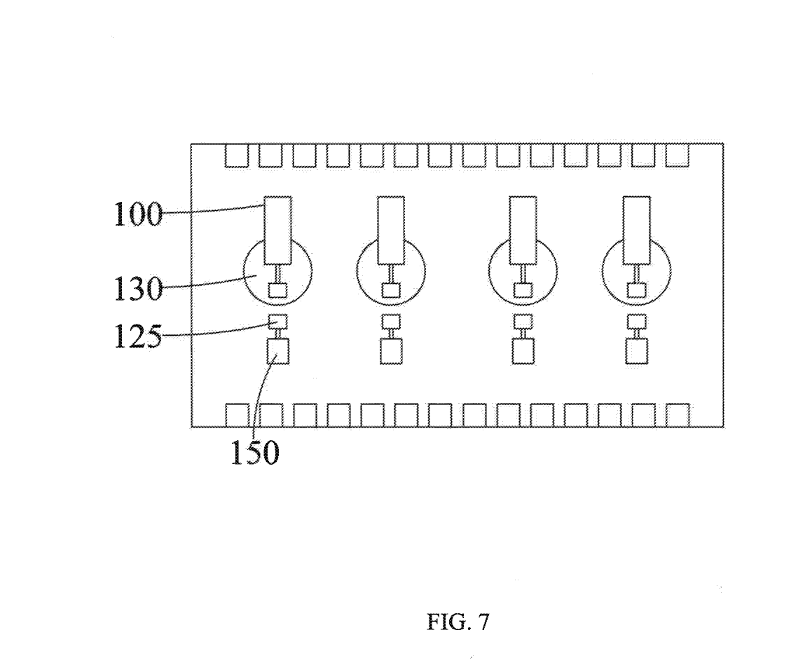

With reference to FIG. 7 for a schematic view of an optocoupler according to the forth embodiment of the present invention, the present embodiment can manufacture a plurality of optocouplers based on the substrate 120. Wherein, the optocoupler of the present invention can be the optocoupler 10 of the first embodiment, the optocoupler 20 of the second embodiment, or the optocoupler 30 of the third embodiment. By forming the plurality of the optocouplers 10, 20 or 30 on the substrate, the cost of manufacturing may effectively decrease.

In summary, by using the flip chip technology to form multiple metal bumps on the receiving unit, and then connecting metal bumps to the substrate, forming the transparent light guiding block on the light-emitting unit, covering the receiving unit, light-emitting unit and the transparent light guiding block formed on the substrate by the black or white opaque layer, the present invention has a more simpler structure compared to the conventional optocoupler comprising transparent light guiding blocks respectively on the photosensor and the light-emitting unit.

While the means of specific embodiments in present invention has been described by reference drawings, numerous modifications and variations could be made thereto by those skilled in the art without departing from the scope and spirit of the invention set forth in the claims.

What is claimed is:

1. An optocoupler, comprising:
a receiving unit, comprising a photosensor disposed on a first surface of the receiving unit;
a metal bump formed on the first surface of the receiving unit;
a substrate, having a second surface faced to the first surface and the metal bump is connected to the substrate;
a transparent light guiding block connected to the photosensor and arranged to guide the light to the photosensor;
a light-emitting unit covered by the transparent light guiding block; and
a transmitting unit connected to the light-emitting unit and arranged to selectively control the light-emitting unit to emit the light or not.

2. The optocoupler of claim 1, wherein the metal bump has a predetermined thickness, the transparent light guiding block is connected to both the photosensor and the second surface, and the light-emitting unit is faced to the photosensor.

3. The optocoupler of claim 1, wherein the transmitting unit is placed on a side of the receiving unit and is disposed on the second surface of the substrate.

4. The optocoupler of claim 1, wherein the substrate further comprises a recess disposed on the second surface and faced to the photosensor, and the light-emitting unit is placed inside the recess.

5. The optocoupler of claim 1, wherein the substrate has a metal connecting line electrical connected to the transmitting unit and the light-emitting unit, and the light-emitting unit is disposed opposite to the photosensor.

6. The optocoupler of claim 1, further comprising an opaque layer covering the receiving unit, the metal bump, the transparent light guiding block, the light-emitting unit and the transmitting unit.

7. The optocoupler of claim 1, wherein the receiving unit is connected to the second surface of the substrate through the metal bump by the flip chip technology.

8. The optocoupler of claim 1, wherein the substrate is a print-circuit board.

9. The optocoupler of claim 1, wherein the transparent light guiding block is made of a transparent silicon material.
